(19) United States
(12) Patent Application Publication
(10) Pub. No.: US 2025/0215533 A1
(43) Pub. Date: Jul. 3, 2025

(54) SINTERED BODY AND CUTTING TOOL

(71) Applicant: NTK CUTTING TOOLS CO., LTD., Komaki-shi (JP)

(72) Inventors: Yoshito Kojima, Aichi (JP); Kentaro Yamamoto, Aichi (JP); Ryoji Toyoda, Aichi (JP)

(73) Assignee: NTK CUTTING TOOLS CO., LTD., Komaki-shi (JP)

(21) Appl. No.: 18/851,500

(22) PCT Filed: Feb. 13, 2023
(86) PCT No.: PCT/JP2023/004700

§ 371 Date: Sep. 26, 2024

(30) Foreign Application Priority Data
Mar. 30, 2022 (JP) 2022-056475

(51) Int. Cl. C22C 29/02; B23B 27/14; C22C 1/051

(52) U.S. Cl. CPC C22C 29/02; B23B 27/14; C22C 1/051; B23B 2200/325

(57) ABSTRACT

The present disclosure provides a sintered body and a cutting tool that exhibit excellent wear resistance and fracture resistance in high-speed machining. A sintered body (2) comprises: hard particles containing, as a major component thereof, TiN, TiC, TiCN or (Ti, M)(C, N)(where M is one or more types selected from elements (excluding Ti element) which belong to families 4 to 6 of the periodic table); and a binder phase that contains at least one type of Co and Ni. The binder phase further contains at least one type selected from Mo and W. The sintered body (2) contains an intermetallic compound of Co and/or Ni and Mo and/or W.

### TECHNICAL FIELD

The present disclosure relates to a sintered body and a cutting tool.

### BACKGROUND ART

A cutting tool has been known which employs, as its base material, cemented carbide or cermet comprising: a hard phase whose major component is tungsten carbide or titanium carbonitride; and a binder phase whose major component is an iron group element (see, for example, Patent Document 1).

### CITATION LIST

### Patent Document

Patent Document 1: WO2008/146856

### SUMMARY

### Technical Problem

Meanwhile, although a cutting tool whose base material is made of cemented carbide or cermet typically has excellent fracture resistance, such cutting tool may face plastic deformation during high-speed machining, due to the use of relatively low melting point metal such as Co or Ni in its binder phase. Therefore, such cutting tool is not suitable for high-speed machining. Although it may be possible to use a high melting point material for the binder phase in order to improve wear resistance so as to prevent the occurrence of plastic deformation even during high-speed machining, considering applications toward tools which are used for various machining techniques, improvements in fracture resistance are still required.

The present disclosure has been made under the above circumstances, and an object thereof is to provide a sintered body and a cutting tool that exhibit excellent wear resistance and fracture resistance in high-speed machining. The present disclosure can be implemented in the following modes.

### Solution to Problem

[1] A sintered body, containing:
hard particles that contain, as a major component thereof, TiN, TiC, TiCN or (Ti, M)(C, N)(where M is one or more types selected from elements (excluding Ti element) which belong to families 4 to 6 of the periodic table); and
a binder phase that contains at least one type of Co and Ni, in which:
the binder phase further contains at least one type selected from Mo and W; and
the sintered body contains an intermetallic compound of Co and/or Ni and Mo and/or W.

[2] The sintered body according to [1], in which:
the binder phase contains only Co from among Co and Ni, contains only Mo from among Mo and W, and further contains Re;
the content of Co is 45% by mass or more and 90% by mass or less;
the content of Mo is 5% by mass or more and 50% by mass or less;
the content of Re is 5% by mass or more and 50% by mass or less; and
the total content of Co, Mo and Re is 100% by mass.

[3] A cutting tool that uses the sintered body according to [1] or [2].

[4] A cutting tool including the sintered body according to [1] or [2] as a base material, wherein a coating layer is formed on a surface of the base material.

### Advantageous Effects of Invention

According to the present disclosure, it is possible to provide a sintered body that is excellent in wear resistance and fracture resistance in high-speed machining.

By employing the hard phase whose major component is a Ti compound which is excellent in reaction resistance with respect to iron (Fe) and hardness, a sintered body having an excellent wear resistance can be achieved. By configuring the binder phase whose major component is Co or Ni so as to contain at least one type selected from Mo and W, it is possible to improve the heat resistance of the binder phase itself. As a result, it is possible to obtain a sintered body excellent in wear resistance and plastic deformation resistance even in high-speed machining. In addition, by configuring the sintered body so as to contain an intermetallic compound of Co and/or Ni and Mo and/or W, the sintered body can exhibit an excellent plastic deformation resistance.

When the binder phase contains only Co from among Co and Ni, contains only Mo from among Mo and W, and further contains Re, and when, on the basis of the total content of Co, Mo and Re being 100%, the content of Co is 45% by mass or more and 90% by mass or less, the content of Mo is 5% by mass or more and 50% by mass or less, and the content of Re is 5% by mass or more and 50% by mass or less, it is possible to enhance the wear resistance and the plastic deformation resistance.

By employing the sintered body of the present disclosure in a cutting tool, it is possible to provide a cutting tool that is excellent in wear resistance and fracture resistance.

When a coating layer is formed on a surface of the cutting tool, it is possible to harden the surface and inhibit oxidation of the base material coated by the coating layer, and it is therefore possible to further improve the wear resistance of the cutting tool.

### BRIEF DESCRIPTION OF DRAWINGS

FIG. 1 is a perspective view showing an example of a sintered body (cutting tool).

FIG. 2 is a cross-sectional view taken along line A-A.

### DESCRIPTION OF EMBODIMENTS

The present disclosure will be described in detail below. In the present specification, a statement which expresses a numerical range using “to” includes the lower limit value and the upper limit value of such numerical range, unless otherwise indicated. For example, the statement “10 to 20” includes both its lower limit value “10” and its upper limit value “20.” In other words, the statement “10 to 20” has the same meaning as the statement “10 or more and 20 or less.”

### 1. Sintered Body

### (1) Configuration of Sintered Body

A sintered body contains: hard particles whose major component is TiN, TiC, TiCN or (Ti, M)(C, N)(where M is one or more types selected from the elements (excluding Ti element) which belong to families 4 to 6 of the periodic table); and a binder phase which contains at least one type of Co (cobalt) and Ni (nickel). The binder phase further contains at least one type selected from Mo (molybdenum) and W (tungsten). The sintered body contains an intermetallic compound having Co and/or Ni and Mo and/or W.

### (2) Hard Particles

The hard particles contain, as the major component thereof, TiN, TiC, TiCN or (Ti, M)(C, N)(where M is one or more types selected from the elements (excluding Ti element) which belong to families 4 to 6 of the periodic table). The “major component” here means that a Ti compound constitutes 60% by volume or more on the basis of hard particles being 100% by volume. M may preferably be at least one type of element selected from Ta (tantalum), Nb (niobium), W (tungsten), V (vanadium), Cr (chrome), Zr (zirconium), Mo (molybdenum) and Hf (hafnium). From among these elements, at least one type of element selected from Ta (tantalum), Nb (niobium) and W (tungsten) is more preferable, and Ta and/or Nb is further preferable. The composition ratio of the elements that constitute the hard particles is not particularly limited.

The hard particles may be particles of a single component or may be particles containing multiple components (which may be, for example, particles having a core-rim structure). The composition ratio of elements constituting TiC, TiN, TiCN or (Ti, M)(C, N) is not particularly limited. For example, the ratio between C and N in TiCN is not particularly limited, the ratio between C and N may be a non-stoichiometric ratio, and there may only be one type of hard particles or may alternatively be more than one type. The state in which there is more than one type of hard particles refers to not only a state in which (Ti, M)(C, N) particles with different elements M coexist, but also a state in which (Ti, M)(C, N) particles with the same element M, but different composition ratio between Ti, M, C and N that constitute the particles, coexist.

The ratio between the composition ratio XC of carbon and the composition ratio XN of nitrogen, as expressed by (XN/(XC+XN)), is preferably in the range of 0.10 to 0.90, more preferably in the range of 0.20 to 0.80, and further preferably in the range of 0.30 to 0.70, from the viewpoint of reaction resistance with respect to iron contained in a workpiece.

The ratio between the composition ratio XTi of titanium and the composition ratio XM of metal element M, as expressed by (XTi/(XTi+XM)), is preferably in the range of 0.40 to 0.95, more preferably in the range of 0.50 to 0.95, and further preferably in the range of 0.70 to 0.95, from the viewpoint of hardness.

The content (% by volume) of each substance in the sintered body can be calculated by determining the amount of each element using fluorescent X-ray analysis, etc.

The content of the hard particles in the sintered body is not particularly limited. The content of the hard particles, on the basis of the sum of the hard particles, the binder phase and dispersed particles (described later) being 100% by volume, is preferably 65% by volume or more and 95% by volume or less, more preferably 75% by volume or more and 90% by volume or less, and further preferably 80% by volume or more and 85% by volume or less, from the viewpoint of enhancing the wear resistance and the plastic deformation resistance.

### (3) Binder Phase

The binder phase contains at least one type of Co and Ni. By configuring the binder phase so as to contain at least one type of Co and Ni, binding between the hard particles and dispersed particles (described later) can be enhanced. Accordingly, the wear resistance and the fracture resistance of the sintered body can be enhanced.

The binder phase further contains at least one type selected from Mo and W. With such configuration, it is possible to inhibit high-temperature softening of the binder phase, which makes it possible to make the sintered body less prone to plastic deformation.

### (4) Requirements Concerning Binder Phase

The binder phase preferably contains only Co from among Co and Ni, contains only Mo from among Mo and W, and further contains Re. Mo forms a solid solution within the hard particles, which can serve as an intermediate layer between the hard particles and the binder phase and enhance the fracture resistance of the sintered body. In addition, by configuring the binder phase so as to further contain Re, being a high melting point metal, it is possible to further inhibit the high-temperature softening of the binder phase. Therefore, the sintered body becomes less prone to plastic deformation.

On the basis of the total content of Co, Mo and Re being 100% by mass, it is preferable that the content of Co is 45% by mass or more and 90% by mass or less, the content of Mo is 5% by mass or more and 50% by mass or less, and the content of Re is 5% by mass or more and 50% by mass or less. With such configuration, it is possible to enhance the wear resistance and the plastic deformation resistance of the sintered body. It should be noted that the binder phase may contain impurities other than Co and Mo.

By setting the content of Co to 45% by mass or more, the fracture resistance can be enhanced. By setting the content of Mo to 5% by mass or more, the plastic deformation resistance and the wear resistance can be enhanced. By setting the content of Mo to 50% by mass or less, the fracture resistance can be enhanced. Mo serves as an origin of production of Co₃Mo to be described later. By setting the content of Re to 5% by mass or more, the plastic deformation resistance and the wear resistance can be enhanced. By setting the content of Re to 50% by mass or less, the fracture resistance can be enhanced.

From the viewpoint of enhancing the wear resistance and the plastic deformation resistance, the sintered body preferably has 3% by volume or more and 10% by volume or less of binder phase, and more preferably has 5% by volume or more and 8% by volume or less of binder phase, on the basis of the sum of the hard particles, the binder phase, and dispersed particles (described later) being 100% by volume.

### (5) Intermetallic Compound

The sintered body contains an intermetallic compound of Co and/or Ni and Mo and/or W. More specifically, the intermetallic compound may be a compound of Co and Mo, a compound of Co and W, a compound of Ni and Mo, a compound of Ni and W, a compound of Co, Ni and Mo, a compound of Co, Ni and W, a compound of Co, Mo and W, a compound of Ni, Mo and W, or a compound of Co, Ni, Mo and W. The intermetallic compound is preferably Co₃Mo or Co₃W. By configuring the sintered body so as to contain such intermetallic compound, it is possible to enhance the plastic deformation resistance.

### (6) Particles Containing Al (Dispersed Particles)

The sintered body preferably contains dispersed particles containing Al (aluminum). The dispersed particles containing Al exist in a dispersed manner within the sintered body and inhibit the grain growth of the hard particles. In the following description, the particles containing Al will also be referred to as “dispersed particles.”

Examples of the dispersed particles may be particles consisting of one or more types of nitrides, oxides and oxynitrides of Al. For example, the dispersed particles may consist of one or more types of AlN particles (aluminum nitride particles), Al₂O₃ particles (aluminum oxide particles) and AlON particles (aluminum oxynitride particles).

The dispersed particles are preferably AlN particles. The AlN particles increase the coefficient of thermal conductivity of a cutting tool which is formed of the sintered body and decrease its coefficient of thermal expansion. Accordingly, by employing the AlN particles as the dispersed particles, it is possible to exhibit even more excellent wear resistance and fracture resistance during high-speed machining and extend the tool lifetime.

The content of the dispersed particles is not particularly limited. The content of the dispersed particles is preferably 5% by volume or more and 20% by volume or less, and more preferably 5% by volume or more and 10% by volume or less, on the basis of the entire sintered body being 100% volume. When the content of the dispersed particles is within such range, it is possible to inhibit diffusion wear during high-speed machining, and therefore possible to enhance the wear resistance of the tool. In addition, even if the sintering temperature becomes high during manufacturing due to an increase in the melting point (increased heat resistance) of the binder phase, it is still possible to effectively inhibit the grain growth of the hard particles and a finer texture can be obtained, and it is therefore possible to enhance the wear resistance and the fracture resistance of the tool.

### 2. Manufacturing Method of Sintered Body

The manufacturing method of the sintered body is not particularly limited. An example of the manufacturing method of the sintered body will now be described below.

### (1) Raw Material

The following material powders are used as raw materials.
Ti carbonitride-based material powder
One or more types of material powder selected from TaC powder (tantalum carbide powder), NbC powder (niobium carbide powder) and WC powder (tungsten carbide powder), or a solid solution powder thereof
Material powder such as AlN powder (aluminum nitride powder), Al₂O₃ powder (aluminum oxide powder), etc.
Material powder such as Co powder, Ni powder, Re powder, Mo powder, W powder, etc.

### (2) Preparation of Powder for Sintering

The material powders are weighed so as to meet a predetermined compounding ratio. The material powders, ball stones (e.g., Al₂O₃ ball stones) and a solvent (e.g., acetone) are placed in a container (e.g., resin pot) and mixed and pulverized. The resulting slurry is treated by double-boiling and drying to obtain a dried mixed powder.

### (3) Sintering

The dried mixed powder is subjected to press-forming and then to atmospheric sintering to obtain a sintered body 2. The atmospheric sintering is performed under an Ar or N₂ atmosphere. The generation of the intermetallic compound of Co and/or Ni and Mo and/or W is controlled by means of a cooling rate during sintering.

### 3. Cutting Tool

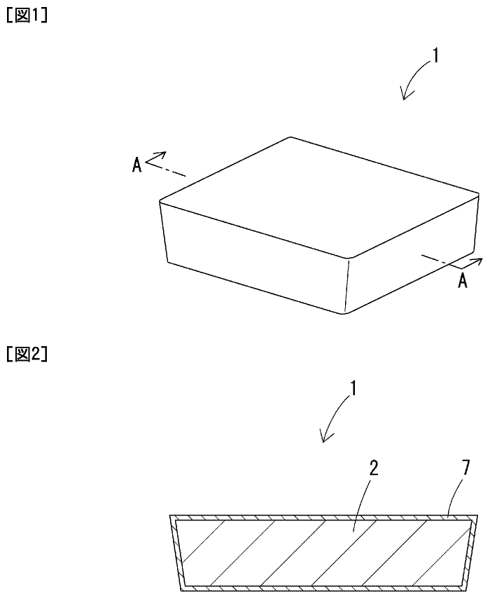

As shown in FIGS. 1 and 2, a cutting tool 1 is formed by using the above-described sintered body 2. The shape of the cutting tool 1 is not particularly limited.

The sintered body 2 is shaped and surface-finished by at least one machining process such as cutting, grinding and polishing to produce a cutting tool 1. Needless to say, if these finishing processes are not necessary, the sintered body 2 may be used as-is as the cutting tool 1.

In the cutting tool 1, the sintered body 2 may be used as a base material and a coating layer 7 may be formed on a surface of the base material. Although not particularly limited, the coating layer 7 is preferably made of at least one compound selected from, for example, carbides, nitrides, oxides, carbonitrides, carboxides, oxynitrides and oxycarbonitrides of titanium, zirconium, chromium and aluminum. When the coating layer 7 is formed, the surface hardness of the cutting tool 1 can be increased and oxidation of the base material coated by the coating layer 7 can be inhibited, and the wear resistance of the cutting tool 1 can therefore be enhanced.

Although the at least one compound selected from carbides, nitrides, oxides, carbonitrides, carboxides, oxynitrides and oxycarbonitrides of titanium, zirconium, chromium and aluminum is not particularly limited, suitable examples thereof may include TiN, TiAlN, TiCrAlN and CrAlN. Cr-based compounds (e.g., TiCrAlN and CrAlN) are more preferable, from the viewpoint of oxidation resistance and lubricity.

The form of the coating layer 7 may either be a single layer or a laminate layer having multiple layers laminated on top of another.

The thickness of the coating layer 7 is not particularly limited. The thickness of the coating layer 7 is preferably 0.02 μm or more and 30 μm or less, from the viewpoint of wear resistance.

It should be noted that, regarding the various numerical ranges described in this specification, the upper limit value and the lower limit value of each numerical range may be combined as appropriate, and all of such combinations are understood as being described herein as preferable numerical ranges.

### EXAMPLES

The present disclosure will now be further described in detail by means of examples.

In the following description, Experimental Examples 1, 3 and 5-19 are examples, whereas Experimental Examples 2 and 4 are comparative examples.

In the table below, the experimental examples will be shown using “No.,” and the numbers with the “*” mark, such as “*2,” in the table show comparative examples.

### 1. Experimental Examples 1-19

The sintered bodies in Experimental Examples 1-19 were prepared and machined to form the cutting tools of Experimental Examples 1-19, respectively. In the compositions shown in Table 1, the sum of components contained therein is 100% by volume. In Table 1, the composition “(Ti, Nb) (C, N)-9% AlN-5% (Co, Mo)” in Experimental Example 1 means that (Ti, Nb)(C,N), AlN, and (Co, Mo) are contained in amounts of 86% by volume, 9% by volume and 5% by volume, respectively.

In Table 1, the compositions of Experimental Examples 1 and 2 do not describe Re and therefore do not contain any Re.

In Table 1, the “Co/Ni” column in the “Component Ratio of Binder Phase” section indicates that either Co or Ni is contained in the binder phase. In the same way, the “Mo/W” column indicates that either Mo or W is contained in the binder phase. For example, in Experimental Example 1, Co from among Co and Ni is contained in the binder phase, and in Experimental Example 11, Ni from among Co and Ni is contained in the binder phase.

### (1) Material Powder

The material powders shown below were used.
Ti carbonitride-based material powder: Average particle diameter of 1.5 μm or less
NbC powder: Average particle diameter of 1.5 μm or less
Al₂O₃ powder: Average particle diameter of 0.7 μm or less
AlN powder: Average particle diameter of 0.7 μm or less
Co powder: Average particle diameter of 5.0 μm or less
Ni powder: Average particle diameter of 5.0 μm or less
Re powder: Average particle diameter of 5.0 μm or less
Mo powder: Average particle diameter of 5.0 μm or less
W powder: Average particle diameter of 5.0 μm or less

### (2) Preparation of Sintered Body (Experimental Examples 1-19)

The material powders were used to prepare mixed powder, acetone was added to the mixed powder, and pulverization and mixing were performed for 72 hours. After the pulverization and mixing, the resulting slurry was subjected to double-boiling and drying to remove acetone, and dried mixed powder was thereby prepared. The resulting dried mixed powder was subjected to press forming and then to atmospheric sintering to obtain a sintered body. The atmospheric sintering was performed under the condition of the sintering temperature of 1550° C. to 1750° C., and in the Ar or N₂ atmosphere. Regarding the case in which densification was difficult (Experimental Example 14), an HIP process was performed as appropriate. The HIP process was performed under the condition of 1550° C., 150 MPa, and an Ar atmosphere. The composition (vol %), the sintering temperature and the rate of temperature increase in each experimental example are shown in Table 1.

The generation of an intermetallic compound of Co and/or Ni and Mo and/or W was controlled by means of the cooling rate during primary sintering. More specifically, the cooling rate to the sintering temperature of 1000° C. was set to 15° C./min or less to generate the intermetallic compound.

TABLE 1

| | | | | | | Primary Sintering | | | | | |
|---|---|---|---|---|---|---|---|---|---|---|---|
| | | Component Ratio | | | Inter- | Condition | | | | Cutting Test Result | |
| | | of Binder Phase | | | metallic | (HIP Condition) | | | | Plastic | Amount |
| | | (% by mass) | | | Com- | Sintering | Cooling | | | Defor- | of Wear |
| No. | Composition (% by volume) | Co/Ni | Mo/W | Re | pound | Temp. | Rate | | Coating | mation | (mm) |
| 1 | (Ti, Nb)(C, N)—9% AlN—5%(Co, Mo) | 80 | 20 | — | Co₃Mo | 1600° C. | −5° | C./min | — | Absent | 0.13 |
| *2 | (Ti, Nb)(C, N)—9% AlN—5%(Co, Mo) | 80 | 20 | — | — | 1600° C. | −20° | C./min | — | Present | — |
| 3 | (Ti, Nb)(C, N)—9% AlN—5%(Co, Re, Mo) | 90 | 5 | 5 | Co₃Mo | 1600° C. | −5° | C./min | — | Absent | 0.08 |
| *4 | (Ti, Nb)(C, N)—9% AlN—5%(Co, Re, Mo) | 90 | 5 | 5 | — | 1600° C. | −20° | C./min | — | Present | — |
| 5 | (Ti, Nb)(C, N)—9% AlN—5%(Co, Re, Mo) | 60 | 20 | 20 | Co₃Mo | 1600° C. | −10° | C./min | — | Absent | 0.04 |
| 6 | (Ti, Nb)(C, N)—9% AlN—5%(Co, Re, Mo) | 45 | 5 | 50 | Co₃Mo | 1600° C. | −5° | C./min | — | Absent | 0.06 |
| 7 | (Ti, Nb)(C, N)—9% AlN—5%(Co, Re, Mo) | 45 | 50 | 5 | Co₃Mo | 1600° C. | −10° | C./min | — | Absent | 0.05 |
| 8 | (Ti, Nb)(C, N)—5%(Co, Re, Mo) | 60 | 20 | 20 | Co₃Mo | 1550° C. | −10° | C./min | — | Absent | 0.15 |
| 9 | (Ti, Nb)(C, N)—5% AlN—5%(Co, Re, Mo) | 60 | 20 | 20 | Co₃Mo | 1550° C. | −10° | C./min | — | Absent | 0.05 |
| 10 | (Ti, Nb)(C, N)—5% AlN—5%(Co, Re, W) | 60 | 20 | 20 | Co₃W | 1600° C. | −10° | C./min | — | Absent | 0.10 |
| 11 | (Ti, Nb)(C, N)—5% AlN—5%(Ni, Re, Mo) | 60 | 20 | 20 | Ni₃Mo | 1550° C. | −10° | C./min | — | Absent | 0.09 |
| 12 | (Ti, Nb)(C, N)—20% AlN—5%(Co, Re, Mo) | 60 | 20 | 20 | Co₃Mo | 1700° C. | −10° | C./min | — | Absent | 0.09 |
| 13 | (Ti, Nb)(C, N)—9% Al2O3—5%(Co, Re, Mo) | 60 | 20 | 20 | Co₃Mo | 1600° C. | −10° | C./min | — | Absent | 0.07 |
| 14 | (Ti, Nb)(C, N)—9% AlN—3%(Co, Re, Mo) | 60 | 20 | 20 | Co₃Mo | 1750° C. | −10° | C./min | — | Absent | 0.04 |
| | | | | | | (1550° C.) | | | | | |
| 15 | (Ti, Nb)(C, N)—9% AlN—8%(Co, Re, Mo) | 60 | 20 | 20 | Co₃Mo | 1575° C. | −10° | C./min | — | Absent | 0.13 |
| 16 | (Ti, Nb)(C, N)—9% AlN—10%(Co, Re, Mo) | 60 | 20 | 20 | Co₃Mo | 1550° C. | −10° | C./min | — | Absent | 0.16 |
| 17 | (Ti, Nb)(C, N)—9% AlN—8%(Co, Re, Mo) | 60 | 20 | 20 | Co₃Mo | 1600° C. | −10° | C./min | TiN | Absent | 0.11 |
| 18 | (Ti, Nb)(C, N)—9% AlN—8%(Co, Re, Mo) | 60 | 20 | 20 | Co₃Mo | 1600° C. | −10° | C./min | TiAlN | Absent | 0.09 |
| 19 | (Ti, Nb)(C, N)—9% AlN—8%(Co, Re, Mo) | 60 | 20 | 20 | Co₃Mo | 1600° C. | −10° | C./min | CrAlN | Absent | 0.10 |

### (3) Preparation of Cutting Tool

The sintered bodies of Experimental Examples 1-19 were each polished so as to have a predetermined dimension to thereby prepare a cutting tool. Coating was applied to the sintered bodies of Experimental Examples 17-19.

### (4) Checking of Intermetallic Compound

Regarding the resulting samples, XRD analysis was performed at a surface (flank) of each tool to check the presence or absence of the intermetallic compound described above.

(5) Wear Resistance Performance Evaluation Test with Respect to Carbon Steel

### (5.1) Test Conditions

Each cutting tool was used to perform a cutting test. The test conditions were as follows.
Insert Shape: CNMN120408T00520
Workpiece: S45C (JIS)
Cutting Speed: 500m/min
Cutting Depth: 3.0 mm
Feed Rate: 0.4 mm/rev.
Cutting Environment: Dry Turning Test

### (5.2) Evaluation

The evaluation results are also shown in Table 1. The evaluation was conducted on the basis of the cutting distance up to the end of life, by employing the following items as the criteria for the lifetime. When no plastic deformation was observed during machining up to the cutting distance of 1 km, the cutting tool was evaluated as having passed. When the amount of deformation of a cutting edge exceeded 0.1 mm with respect to the flank as a reference surface, it was determined that “plastic deformation” had occurred.

The amount of VB wear at the cutting distance of 1 km was evaluated.

### (6) Evaluation Results

### (6.1) Regarding Presence or Absence of Intermetallic Compound

Experimental Examples 1 and 2 will now be compared and discussed below. Experimental Example 2, having no intermetallic compound, caused plastic deformation and was determined as having failed. Experimental Example 1, having an intermetallic compound, caused no plastic deformation and was determined as having passed. While Experimental Example 2, having no intermetallic compound, exhibited inferior plastic deformation resistance, Experimental Example 1, having an intermetallic compound, exhibited improved plastic deformation resistance.

### (6.2) Regarding Composition of Binder Phase

Experimental Examples 1, 3 and 5-7 will now be compared and discussed below. Experimental Example 1, which contained no Re in its binder phase, exhibited the amount of wear of 0.13 mm. Experimental Examples 3 and 5-7, which each contained Re in their binder phase and satisfied requirement (a) below, exhibited the amounts of wear of 0.04 mm to 0.08 mm.
Requirement (a): On the basis of the total content of Co, Mo and Re being 100% by mass, the content of Co is 45% by mass or more and 90% by mass or less, the content of Mo is 5% by mass or more and 50% by mass or less, and the content of Re is 5% by mass or more and 50% by mass or less.

By having Re contained in the binder phase and satisfying the above-described requirement (a), no plastic deformation occurred, and the amount of wear of the tool was reduced.

### (6.3) Regarding Presence or Absence of Dispersed Particles

Experimental Examples 5 and 8-13 will now be compared and discussed below. Experimental Example 8, which contains no dispersed particles (particles containing Al), exhibited the amount of wear of 0.15 mm. Experimental Examples 5 and 13, containing dispersed particles, exhibited the amounts of wear of 0.04 mm and 0.07 mm, respectively. The amount of wear in the resulting tool was reduced by configuring the sintered body so as to contain dispersed particles containing Al.

Experimental Example 5, whose dispersed particles were AlN particles, exhibited the amount of wear of 0.04 mm. Experimental Example 13, whose dispersed particles were Al₂O₃ particles, exhibited the amount of wear of 0.07 mm. As dispersed particles, AlN particles exhibited an improved wear resistance compared to Al₂O₃ particles.

In Experimental Examples 5, 9 and 12, with the content of dispersed particles of 9% by volume, 5% by volume and 20% by volume, respectively, on the basis of the entire sintered body being 100% by volume, the amounts of wear were 0.04 mm, 0.05 mm and 0.09 mm, respectively. High wear resistance could be achieved by setting the content of the dispersed particles to 5% by volume or more and 20% by volume or less.

### (6.4) Regarding Components of Binder Phase

In Experimental Example 9, containing Co, Re and Mo in its binder phase, the amount of wear was 0.05 mm. In Experimental Example 10, containing Co, Re and W in its binder phase, the amount of wear was 0.10 mm. In Experimental Example 11, containing Ni, Re and Mo in its binder phase, the amount of wear was 0.09 mm. Sintered bodies that contained either Co or Ni in the components of their binder phase exhibited high wear resistance. Sintered bodies that contained either Mo or W in the components of their binder phase exhibited high wear resistance.

### (6.5) Regarding Amount of Binder Phase

In Experimental Examples 3 and 14-16, with the amount of binder phase of 5% by volume, 3% by volume, 8% by volume and 10% by volume, respectively, on the basis of the sum of the hard particles, the binder phase and the dispersed particles being 100% by volume, the amounts of wear were 0.08 mm, 0.04 mm, 0.13 mm and 0.16 mm, respectively. Sufficient tool performance (high wear resistance) could be achieved with the binder phase of 3% by volume or more and 10% by volume or less.

Experimental Examples 1, 3 and 5-19 each resulted in a sintered body and a cutting tool that exhibited excellent wear resistance and fracture resistance in high-speed machining. With such cutting tool, it is possible to improve a cutting speed when machining steel and improve performance in the cutting process.

The present disclosure is not limited to the embodiments described in detail above, and various modifications and changes can be made within the scope of the appended claims.

### REFERENCE SIGNS LIST

1: Cutting tool
2: Sintered body
7: Coating layer

1. A sintered body, comprising:
hard particles containing, as a major component thereof, TiN, TiC, TiCN or (Ti, M)(C, N) (where M is one or more types selected from elements (excluding Ti element) which belong to families 4 to 6 of a periodic table); and
a binder phase that contains at least one type of Co and Ni, wherein:
the binder phase further contains at least one type selected from Mo and W; and
the sintered body contains an intermetallic compound of Co and/or Ni and Mo and/or W.

2. The sintered body according to claim 1, wherein:
the binder phase contains only Co from among Co and Ni, contains only Mo from among Mo and W, and further contains Re;
the content of Co is 45% by mass or more and 90% by mass or less;
the content of Mo is 5% by mass or more and 50% by mass or less;
the content of Re is 5% by mass or more and 50% by mass or less; and
the total content of Co, Mo and Re is 100% by mass.

3. A cutting tool that uses the sintered body according to claim 1.

4. A cutting tool comprising the sintered body according to claim 1 as a base material, wherein a coating layer is formed on a surface of the base material.

5. A cutting tool that uses the sintered body according to claim 2.

6. A cutting tool comprising the sintered body according to claim 2 as a base material, wherein a coating layer is formed on a surface of the base material.
